(19) United States
(12) Patent Application Publication
(10) Pub. No.: US 2003/0174404 A1
(43) Pub. Date: Sep. 18, 2003

(54) Rain-boot for telescopic sights

(76) Inventor: David M. Kaupanger, Council, ID (US)

Correspondence Address: David Kaupanger, 2538 Council Cuprum Rd., Council, ID, 83612, US

(21) Appl. No.: 10/098,878

(22) Filed: Mar. 12, 2002

(51) Int. Cl. G02B 1/00

(52) U.S. Cl. 359/611; 359/511; 359/600

(57) ABSTRACT

A protective, open-ended, sleeve, FIG. #2, which is easily slipped over the ends of a rifle telescopic sight, hereafter called a ‘boot’. The portion of the boot which slips over the end of the telescope, (4), fits snugly enough for a firm fit. Where the boot extends past the end of the telescope tube it tapers, (5), to a smaller diameter, providing a barrier to rain drops which might reach the lens of the telescope, thus ensuring a constant clear sight picture through the telescope for the hunter. This boot will ensure that there will be no delay in taking that split-second shot at game that may not provide another shot otherwise.

### BACKGROUND

1. Field of Invention

This invention is devised to prevent precipitation from reaching the lenses of a telescopic sight.

2. Description of Prior Art

A variety of devices have been invented to protect the lenses of telescopic sights from the elements.

The lens cap cover is a commonly used device which, when in use, requires mechanical manipulation for removal prior to viewing through the telescope. Examples are: U.S. Pat. No. 3,746,432 to Mills, and U.S. Pat. No. 323,372 to Heckerman.

A similar attachment intended to reduce sun glare on lenses is exemplified by U.S. Pat. No. 3,315,362 to Palmer.

A device called a telescopic sight protector was awarded to Peters, Jr., U.S. Pat. No. 2,968,099.

All of these devices pose a number of disadvantages:

(a) Use of a scope cover (Heckerman) on a telescope while hunting in the field keeps water from reaching the lens, but provides the chance of missing an opportunity to shoot the firearm, since it takes time to remove it.

(b) Use of a device to cover lenses as exemplified by the invention of Mills also requires time to mechanically move the device to allow a sight picture through the telescope.

(c) Devices used to reduce the sun glare on the back lens (Palmer) are intended to be used for target shooting. They are extremely flexible to eliminate damage to the eye due to rifle recoil. It takes time to fit them to the eye, and they droop in hot weather, further extending the time required to find a sight picture to align on the animal.

(d) The Peters Jr. telescopic sight protector expands in diameter as it extends away from the lens. This configuration can be compared to a funnel, which would increase the amount of precipitation which could reach the lens if the barrel of the rifle the telescope is mounted on is occasionally pointed downward, which is often the case.

### OBJECTS AND ADVANTAGES

Use of my patent provides several objects and advantages, and listed below, they are:

(a) to provide a device to prevent water from beading up on telescopic lenses while hunting in inclement weather;

(b) to provide a better means of keeping water off of the lens while still keeping the sight picture open through the telescope;

(c) to provide a means to prevent this beading up of water which ensures a clear sight picture through the lenses;

(d) to provide a means to have a clear sight picture through the lenses of a telescope without any loss of time;

(e) to provide a device which can be attached to the telescope is weather requires, and left on without worrying about getting a quick shot off if necessary;

(f) to allow opportunity for a quicker shot with a clear sight picture at game while hunting.

### DRAWINGS FIGURES

FIG. 1 is a side view of a vertical cross section of the rain-boot.

FIG. 2 is a side elevation view of the body of the rain-boot.

FIG. 3 is a small end view from end (A). In this figure, the view of (5) is exterior.

FIG. 4 is a large end view from end (B). In this figure, the view of (5) is interior.

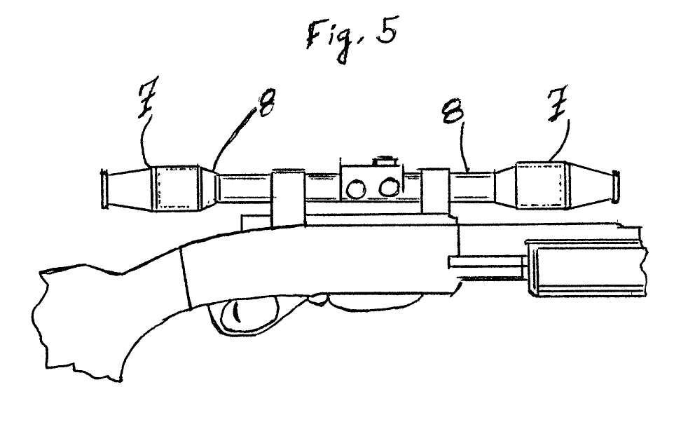

Note: This device can be seen through from end (A) to end (B). The smallest circle in FIGS. 3 and 4 is open.

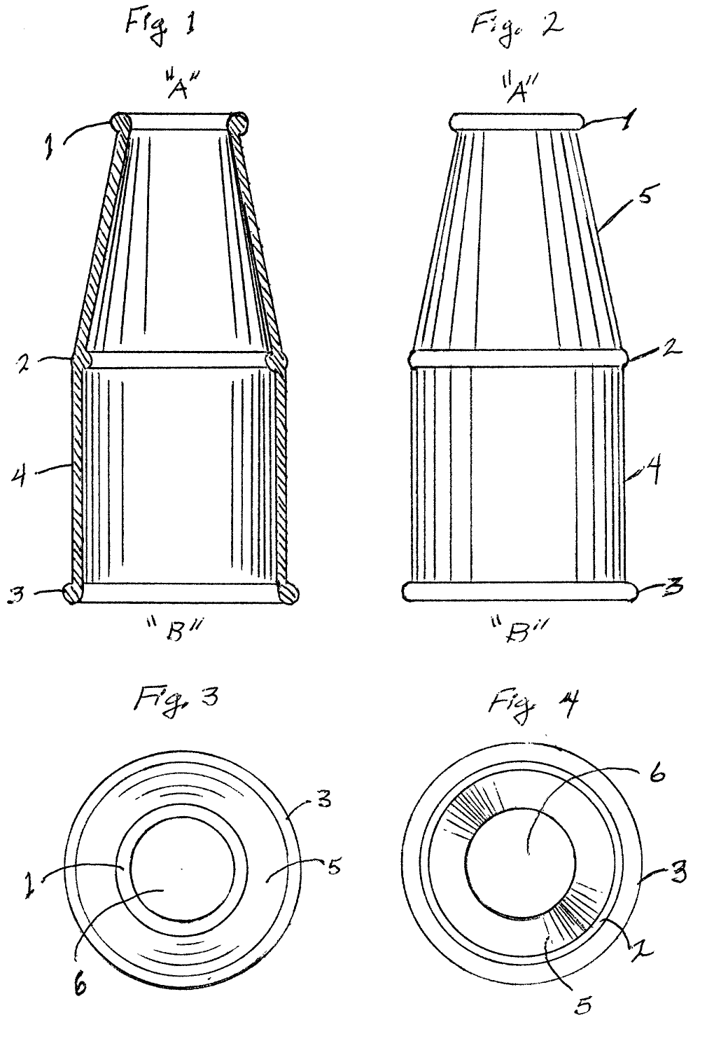

### DESCRIPTION—FIGS. 1 to 5

The preferred embodiment of this device is illustrated in the exterior view depicted in FIG. (2), Drawing #1. The prototype of this preferred embodiment was constructed of a tubular section of synthetic rubber (4), intended to be slipped over the end of the telescope tube for use. A synthetic rubber ‘O’ ring, (3), is attached to the end of (4) at end (B) to form a collar of slightly larger outside diameter to facilitate the action of slipping the device over the end of the telescope. An ‘O’ ring (2), slightly smaller than tubular section (4) is attached to the opposite end of (4) from ‘O’ ring (3), intended to be a stop, so that the device is properly in place on the telescope tube. The portion of the device that is cone shaped, (5), attaches to ‘O’ ring (2) and tapers down to ‘O’ ring (1) at end (A). #(6) is open.

FIG. (5) in Drawing #2 illustrates proper placement of the device, (7), on the telescope, (8).

This is a description of the preferred embodiment of the invention. A variety of slightly diverging embodiments could be made to perform the same results.

Operation of the Device

This invention is of an attachment to be used on a rifle telescope as desired, providing an instantaneous clear sight picture through the telescope. It can be removed and pocketed with ease when no longer needed.

Summary, Ramifications, and Scope

This invention is a great improvement over the closest prior art, the telescopic sight protector invented by Peters Jr. Since the opening through which rain drops would have to enter is much smaller than the lens itself, the rifle upon which the telescope is mounted would have to be held in an almost vertical position, either up or down, for the rain to reach the lenses, front or back. This opening restriction, since it is positioned away far enough from the lens, in no way restricts the sight picture seen through the telescope.

An added benefit of this invention is it actually provides a shield from sunlight also, although its actual purpose is to protect the lenses from being fouled by moisture.

The common practice for hunters who do not want to lose any time getting a shot off with a telescopic rifle is to hold the rifle under the arm while it is raining. Quite often this causes the lens to fog up and they lose a shot anyway. My invention provides a device that hunters can use to improve their hunting experience.

I claim:

1. An attachment for a telescopic sight comprising a sleeve having one of its ends receivable on either end of a telescopic sight and projecting away there from, tapering down to a smaller diameter than said telescope, and said attachment being made of resilient material.
